(19) United States
(12) Patent Application Publication
(10) Pub. No.: US 2025/0301304 A1
(43) Pub. Date: Sep. 25, 2025

(54) User Device Remote Computation in Real Time

(71) Applicant: T-Mobile Innovations LLC, Overland Park, KS (US)

(72) Inventor: Jason Hood, Black Diamond, WA (US)

(21) Appl. No.: 18/615,977

(22) Filed: Mar. 25, 2024

(51) Int. Cl. H04W 8/18; H04W 8/22; H04W 36/08

(52) U.S. Cl. CPC H04W 8/183; H04W 8/22; H04W 36/08

(57) ABSTRACT

A method of providing real-time remote computation for a user equipment (UE). The method comprises executing, by an application at a mobile edge computing system (MECS) at a serving cell site of the UE, an instance of a first virtual machine (VM) hosting at least one user application for the UE. The method further comprises receiving, by the application of the MECS, an application patch for updating the at least one user application. The method further comprises launching an instance of a second VM to host at least an updated version of the at least one user application for the UE, where the updated version of the at least one user application comprises the application patch. The method further comprises executing, by the application of the MECS, the instance of the second VM hosting at least the updated version of the at least one user application for the UE.

### CROSS-REFERENCE TO RELATED APPLICATIONS

None.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Wireless communication networks are widely deployed to provide various types of wireless services to wireless user devices. Examples of wireless services may include, but are not limited to, Internet access, media streaming, mobile gaming, patient monitoring, machine control, industrial automation, and social networking. A wireless network may include a number of wireless access nodes that exchange communication signals with wireless user devices over wireless communication links. Each wireless access node may be connected to a core network that provides connectivity to application servers and/or a transport network (e.g., Internet) via backhaul links. The application servers may serve application services to users of the wireless service devices.

Recent advancements in wireless communication technology, such as fifth generation (5G) as defined by 3rd generation partnership project (3GPP), have been designed to provide fast connectivity speeds, low communication latency, and ultra-reliable connections. These advancements may enable deployments of new application services and/or new types of user devices that were not feasible with previous generations of wireless technology. The deployments of these new application services and/or new types of user devices may bring new challenges. Accordingly, there is a need for continued improvements in wireless communications and wireless user devices.

### SUMMARY

In an embodiment, a method implemented in a communication system to update an application software providing real-time remote computation for a user equipment (UE) is disclosed. The method comprises executing, by an application at a mobile edge computing system comprising one or more servers at a serving cell site of the UE, an instance of a first virtual machine hosting at least one user application for the UE, where the executing the instance of the first virtual machine comprises communicating, by the instance of the first virtual machine with the UE, first user interface traffic associated with execution of the at least one user application on the instance of the first virtual machine. The method further comprises receiving, by the application of the mobile edge computing system, an application patch for updating the at least one user application. The method further comprises launching, by the application of the mobile edge computing system in response to receiving the application patch, an instance of a second virtual machine to host at least an updated version of the at least one user application for the UE, where the updated version of the at least one user application comprises the application patch. The method further comprises transferring, by the application of the mobile edge computing system, user data of the UE from the instance of the first virtual machine to the instance of the second virtual machine. The method further comprises executing, by the application of the mobile edge computing system, the instance of the second virtual machine hosting at least the updated version of the at least one user application for the UE based at least in part on the user data of the UE, where the executing the instance of the second virtual machine comprises communicating, by the instance of the second virtual machine with the UE, second user interface traffic for execution of the updated version of the at least one user application on the instance of the second virtual machine.

In another embodiment, an application implemented in a communication system to provide hand off of real-time remote computations for a user equipment (UE) transitioning between cell sites (or between base stations) is disclosed. The method comprises executing, by an application of a first mobile edge computing system comprising one or more first servers at a first cell site serving the UE, an instance of a first virtual machine hosting at least one user application for the UE based on at least one of a user configuration or user data of the UE, where the executing the instance of the first virtual machine comprises executing, by the instance of the first virtual machine, the at least one user application; and communicating, by the instance of the first virtual machine with the UE, first user interface traffic associated with the execution of the at least one user application on the instance of the first virtual machine. The method further comprises launching, at a second mobile edge computing system comprising one or more second servers at a second cell site, based on an indication of a handover of the UE to the second cell site, an instance of a second virtual machine to host the at least one user application for the UE. The method further comprises executing, by the second mobile edge computing system, the instance of the second virtual machine hosting the at least one user application for the UE based on the at least one of the user configuration or the user data of the UE, where the executing the instance of the second virtual machine comprises executing, by the instance of the second virtual machine, the at least one user application; and communicating, by the instance of the second virtual machine with the UE, second user interface traffic associated with the execution of the at least one user application.

In yet another embodiment, a system is disclosed. The system comprises a mobile edge computing system communicatively coupled to an access node or an access point. The mobile edge computing system comprises at least one processor; at least one non-transitory memory; and an application comprising instructions stored at the at least one non-transitory memory, which when executed by the at least one processor, causes the application to launch an instance of a virtual machine to host at least one user application for a user equipment (UE), where the launching is based on the UE being within a range of the access node or the access point that is in communication with the mobile edge computing system and a subscription of the UE. The instructions when executed by the at least one processor, causes the application further to execute the instance of the virtual machine hosting the at least one user application for the UE, where the executing the instance of the virtual machine comprises receiving, from the UE, a user interface input; executing the at least one user application based on the user interface input; and transmitting, to the UE, based on the executing the at least one user application, a user interface output for display at the UE.

These and other features will be more clearly understood from the following detailed description taken in conjunction with the accompanying drawings and claims.

### BRIEF DESCRIPTION OF THE DRAWINGS

For a more complete understanding of the present disclosure, reference is now made to the following brief description, taken in connection with the accompanying drawings and detailed description, where like reference numerals represent like parts.

FIG. 1 is a block diagram of a communication system according to an embodiment of the disclosure.

FIG. 2 is a signaling diagram of a user device real-time remote computation method with a software update according to an embodiment of the disclosure.

FIG. 3 is a block diagram illustrating a user device real-tome remote computation method with region-specific or cell site-specific software update according to an embodiment of the disclosure.

FIG. 4 is a block diagram illustrating a user device real-time remote computation scenario depicting a hand off of real-time remote computations for a mobile UE according to an embodiment of the disclosure.

FIG. 5 is a flow chart of a method according to an embodiment of the disclosure.

FIG. 6 is a flow chart of another method according to an embodiment of the disclosure.

FIG. 7 is a flow chart of yet another method according to an embodiment of the disclosure.

FIG. 8 is a block diagram of a computer system according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

While recent advancements in wireless communication technology allow for faster connectivity speeds, lower communication latency, and more reliable connections, enabling deployments of new application services and/or new types of devices, the computational complexity at wireless user devices may increase. For instance, video streaming and/or mobile gaming at a higher throughput and with a lower latency may lead to an increase in computational load, memory usage, and/or power consumption at the wireless user devices. As such, there is a continued need to upgrade wireless user devices to higher-performance wireless user devices, for example, with more processing power, a higher memory capacity, and/or a longer lasting battery. These upgrades are costly. On the other hand, the processor(s) and/or the memory (e.g., random access memory (RAM)) at these wireless user devices may be idle for a large portion of the time and only being fully utilized during a short time period (e.g., when a video streaming application is executed). In addition to increasing computational complexity, some of the emerging application services, such as augmented reality (AR), virtual reality (VR), and/or extended reality (XR), may target wireless user devices with a reduced form factor, such as wearable compute devices (e.g., in the form of goggles, eyeglasses, headsets, etc.). However, wireless user devices in a reduced form factor may often be equipped with a lower performance processor or less memory (which may reduce UE capabilities). Further, the number of wireless user devices connecting to networks continues to grow at an exponential rate, which in turn causes network traffic load to increase at a rapid rate. Accordingly, while current wireless communication technology can provide low latency, high throughput, and reliable connections, the current design or paradigm of wireless user device operations and/or deployments may be inefficient.

On the network infrastructure side, there is a shift from centralized cloud computing to edge computing. Centralized cloud computing is a centralized computing framework where cloud resources (e.g., servers, databases, and storage) are managed and housed in a single data center or a few centralized data centers. In contrast, edge computing is a distributed computing framework that brings information (e.g., storage) and computing capabilities (e.g., servers) closer to devices that produce that information and end users that consume that information. Mobile edge computing is a type of edge computing, where information and computing capabilities are brought to the edge of a cellular network, closer to the end users. In some instances, a server located at an edge of a network (e.g., a cellular network), close to an end user, may be referred to as an edge server. An edge server can be any suitable computing system co-located with a cell site or near a cell site. In some examples, an edge server can be an edge router or edge gateway.

The terms “wireless user device” and “user equipment (UE)” may be used interchangeably herein, such that a description referring to one of the terms shall be treated as though the description also referred to the other term. The terms “application”, “service”, “application service”, and “application layer software” may be used interchangeably herein, such that a description referring to one of the terms shall be treated as though the description also referred to the other term.

As used herein, the term “virtual machine (VM)” may refer to a virtual representation of a physical computer system. A VM may emulate a physical computer system in a virtual environment and may include an operating system (OS) and/or application(s). As used herein, the term “an instance of a VM” may refer to a VM (in the form of a software code object or image) that runs on physical hardware or server(s) (e.g., including processor(s), memory, and/or storages), for example, in a cloud computing environment. As used herein, the term “VM image” may refer to a computer file or software code object that when executed on a server or computer system, may emulate a physical computer system.

While mobile edge computing has been deployed to move information and computing abilities closer to end users, edge servers are mostly utilized by application service providers to store contents and/or execute server applications to deliver the contents to the end users. Edge servers may not have been fully utilized by wireless user devices. Further, wireless user devices have not fully taken advantage of the fast connection speed, low latency, ultra-reliability offered by the advanced wireless communication technology in the edge servers. For instance, while application service providers may move server applications to edge servers, user applications are continually being executed on the wireless user devices to communicate with respective server applications.

The present disclosure provides a technical solution to the aforementioned technical problems in the technical field of application deployment and processing to efficiently operate a wireless user device by offloading computations (or “intelligence) of the wireless user device to one or more edge servers at a serving cell site of the wireless user device. As such, the wireless user device may operate as a “dumb terminal” or a “thin client”, for example, with a user interface (UI) application communicating with user applications executed on the one or more edge servers. Stated differently, computations for an application layer software of a wireless user device may be performed remotely in real time at edge server(s) and UI traffic associated with the computations may be communicated between the wireless user device and the edge server(s). User applications may generally refer to applications that are to be consumed by a user of a wireless user device.

In embodiments, a communication system may include a plurality of cell sites, each including an access node (AN) serving one or more UEs. As an example, a first cell site of the plurality of cell sites may serve a UE over a wireless communication link. The communication system may further include a first mobile edge computing system (MECS) including one or more servers (edge servers) at the first cell site that serves the UE. To provide an efficient design, the execution of user applications (e.g., the intensive computations, such as image processing) of the UE may be offloaded to the edge servers, and the UE may execute a UI application to communicate UI traffic with the edge servers. The UI traffic may include user input from a user of the UE and output for display (e.g., in the form of a graphical representation) at the UE. To this end, an instance of a VM may be configured on one or more of the edge servers to host user applications for a specific UE. More specifically, the instance of the VM may be executed on a single edge server or multiple edge servers, and the user applications hosted and executed on the VM may perform real-time remote computations for the specific UE. Stated differently, the user applications are application software that performs real-time remote computations for the UE. Further, the edge server(s) for performing the real-time remote computations for the UE may be located at towers, cell sites, base stations, and/or expressly noted or further generation access points and/or wireless network(s).

For example, an application implemented on the first MECS may launch (or “spin up”) an instance of a first VM to host a user application for the UE. In some instances, the application of the first MECS may be referred to as a VM management application or a hypervisor application. The application of the first MECS may execute the instance of the first VM hosting the user application for the UE. As part of executing the instance of the first VM, the instance of the first VM may execute the user application and communicate first UI traffic related to the user application with the UE. As an example, a user of the UE may select a certain video content for streaming. Instead of performing intensive image computations for video streaming at the UE, these intensive image computations are performed by the instance of the first VM at the first MECS using resources (e.g., computing resources and/or memory resources) of the edge servers. Thus, the UI output communicated by the instance of the first VM may be pixels (e.g., in the form of red, green, blue (RGB)_instructions) that have changed since the last display at the UE. As another example, an AR application (e.g., for gaming, entertainment, medical related operations, etc.) may be executed on the UE (e.g., glasses or goggles) where image(s) may be streamed from the UE to the first VM. A user application may be executed remotely at the first VM to process the image(s) and add augmented components to the image(s). The first VM may send the augmentations back to the UE to be overlaid on the actual image(s) (e.g., in the glasses or goggles). Alternatively, the first VM may send the augmented images back for display at the UE (e.g., in the glasses, goggles, or on a separate screen instead of a live image). In some instances, the instance of the first VM may execute the user application according to a user configuration (e.g., application settings or preferences) of the UE. Further, user data (e.g., photo images, videos, data files, etc.) of the UE may be stored on the instance of the first VM.

With user applications of the UE being executed on the first MECS instead of at the UE, software updates or application patches for those user applications can be applied at the first MECS rather than having to download the application patches via a cell site to the UE. More specifically, the software updates or application patches may refer to software codes and/or objects including updated real-time remote computations for the UE. For instance, the application of the first MECS may receive an application patch for updating the user application. In response to receiving the application patch, the application of the first MECS may launch an instance of a second VM (e.g., a new VM instance) to host an updated version of the user application for the UE, where the updated version of the user application includes the application patch. The application of the first MECS may transfer the user data and/or the user configuration of the UE from the instance of the first VM to the instance of the second VM. Subsequently, the application of the first MECS may execute the instance of the second VM hosting the updated version of the user application for the UE and direct or route UI traffic of the UE to the instance of the second VM. The execution of the instance of the second VM may refer to the instance of the second VM becoming an active or live VM instance. As part of executing the instance of the second VM, the instance of the second VM may execute the updated version of the user application and communicate second UI traffic related to the updated version of the user application with the UE. After the application of the first MECS starts to execute the instance of the second VM, the application of the first MECS may delete (or “kill”) the instance of the first VM (e.g., the previously active or live VM instance).

In some examples, the application of the first MECS may launch or create the instance of the second VM based on a base VM image including the application patch. For instance, the application of the MECS may build the base VM image by replicating (or copying) a VM image of the first VM and applying the application patch to the replicated VM image. In some examples, the application patch may be a common application patch for updating UEs located in a specific geographical region or UEs associated with a specific cell site. For instance, the application of the first MECS may further launch, based on the base VM image, an instance of a third VM to host the updated version of the user application for another UE served by the same first cell site as the UE.

Under a normal operating condition, the application of the first MECS may receive the application patch from an application server via a backhaul link that couples the first cell site to a core network. If, however, there is a fault (or an outage) at the backhaul link during the software update, the application of the first MECS may receive at least a portion of the application patch via a line-of-sight (LOS) link from another cell site. For example, in some instances, the application of the first MECS may receive a first portion of the application patch via the backhaul link and may receive a remaining portion of the application patch via the LOS link while the backhaul link is faulty. After receiving the complete application patch, the application of the first MECS may continue to perform the software update, for example, by launching the instance of the second VM including the updated version of the user application rather than waiting for the backhaul link to recover. In this way, the application of the first MECS may execute the instance of the second VM (including the updated version of the user application) once the backhaul link is recovered from the fault.

In embodiments, the execution of the user application of the UE at the first MECS may be based on a subscription of the UE with a network operator of the first cell site and the first MECS. In an example, the network operator may utilize a tier system for UE subscriptions. For instance, the subscription may define a level of resources (e.g., computing resources, memory resources, storage resources, bandwidth, etc.) that is to be provided to the UE for remote real-time computations, where different subscription levels may be associated with different subscription costs. Accordingly, the application of the first MECS may launch the instance of a first VM to host the user application based on a resource availability of the first VM satisfying a resource requirement associated with a subscription level of the UE.

In some examples, the network operator may provision on-demand services (e.g., using a pay-as-you-go subscription pricing model) where more resources may be allocated from the first MECS to the UE when a certain application is executed. Accordingly, the application of the first MECS may determine at least one of a computing resource requirement or a memory resource requirement for hosting the user application for the UE. The determination may be based on a characteristic (e.g., an application type) of the user application for the UE. As an example, a video-streaming application may utilize more computing and/or memory resources than a social networking application. The first MECS may launch the instance of the first VM to host the user application for the UE further based on a resource availability of the first VM satisfying at least one of the determined computing resource requirement or the memory resource requirement.

In some examples, the network operator may provision subscriptions with a pre-agreement where more resources can be allocated to the UE during a certain time period. For instance, the user application may be a gaming application and a user (e.g., a gamer) of the UE may play the game during evening time, and thus may pay for extra computing resources for usage during the evening time. Accordingly, the application of the first MECS may launch the instance of a first VM to host the user application based on a timer period specified by the subscription of the UE. That is, the application of the first MECS may launch and execute an instance of a fourth VM with less resources to host user application(s) of the UE during a time outside of the specified time period and switch to launch and execute the instance of the first VM during the specified time period.

In some examples, the AN of the first cell site may provide not only connectivity between the first MECS and the UE, but also radio frequency (RF) energy to power at least a portion of the UE. That is, the UE may harvest at least some power from the RF signals received from the first cell site. In an example, the UE may include an on-board battery and the battery may be charged while the UE is within a range of the first cell site. When the UE is out of range of any cell site, the UE may be powered by the battery.

In embodiments, the UE may travel from a geographical area within a range of the first cell site to another geographical area within a range of a second cell site of the plurality of cell sites. To provide the hand off of real-time remote computations for a UE transitioning from the first cell site to the second cell site (or from a first base station to a second base station), an application of a second MECS at the second cell site may launch an instance of a fifth VM to host the user application of the UE. The launching of the instance of the fifth VM may be based on an indication of a handover of the UE to the second cell site. Further, the application of the first MECS may transfer the user configuration and the user data of the UE from the first MECS to the second MECS based on the indication of the handover. Subsequently, the application of the second MECS may further execute the instance of the fifth VM hosting the user application for the UE based on at least one of the user configuration or the user data of the UE. As part of executing the instance of the fifth VM, the instance of the fifth VM may execute the user application and communicate third UI traffic associated with the execution of the user application with the UE.

In some examples, the indication of the handover of the UE to the second cell site on which the second MECS based to launch the instance of the fifth VM may include location information (e.g., geographical coordinates) of the UE. For instance, the location information may be computed by the second cell site and/or the second MECS, for example, based on beamforming information and/or round-trip-delay information from communication with the UE. In other examples, the handover indication may be received from the first cell site or a core network (CN) coupled to the first cell site and/or the second cell site.

In some examples, the executing the instance of the first VM hosting the user application for the UE and the executing the instance of the fifth VM hosting the user application for the UE are associated with the same terminal session of the UE. For instance, a user of the UE may start a terminal session to watch a video while served by the first cell site where the video streaming application is executed by the first MECS. The UE may continue to watch the video after traveling to the second cell site where the video streaming application is executed by the second MECS without the UE restarting the terminal session. That is, the switching of the execution of the video streaming application from the first MECS to the second MECS may be seamless and transparent to the user of the UE.

In embodiments, a “dumb terminal” or “thin client” UE as discussed above may offload computations to a compute device co-located with an access point (AP), for example, while the UE is in communication with the AP via a local WiFi (Electrical and Electronics Engineers (IEEE) 802.11) connection, using substantially similar mechanisms as when offloading computations to an MECS at a serving cell site of a carrier network. That is, if the UE is connected to an AP in a local WiFi network instead of directly to a carrier network, the UE may offload intensive computations to the AP (or the computing device of the AP) instead of having to locate an edge server of the carrier network and offload the computations to the edge server. In general, the UE may offload intensive computations to any suitable edge servers of a carrier network and/or APs in a WiFi network, for example, based on traffic or loads and not necessarily as tightly tied to geography.

Offloading intensive (or “heavy”) computations from a UE to remote edge server(s) and leveraging the fast connectivity speed, low communication latency, and reliable connection provided by advancements in wireless technology (e.g., 5G and future generations of wireless technology) to allow for real-time remote computations can simplify UE design (e.g., resulting in lower-cost UEs) and allow for better resource utilization (where resources at edge servers may be shared among UEs). With user applications being executed on edge servers, network traffic load may be reduced significantly compared to when user applications are being executed on the UEs. UI traffic over wireless communications links between UEs and cell sites may utilize a significantly lower bandwidth than when application data is being communicated over those wireless communications links. For example, updating user applications at edge server(s) without having to download an application patch to each UE reduces the network traffic load. Further, UI traffic over wireless communications links between UEs and cell sites may utilize a significantly lower bandwidth than when application data (content data) is being communicated. As an example, when a user application such as a video streaming application is executed at a UE, video frame data (application data) is being transmitted (over a wireless communication link) from a serving cell site to the UE. In contrast, when the video streaming application is executed on an edge server, instructions such as RGB codes or instructions (e.g., integer values) are being transmitted (over a wireless communication link) from the serving cell site to the UE (to update a display of the UE). As such, traffic profiles over those wireless communication links may be more uniform because each UE (“dumb terminal” UE) may communicate, with a respective serving cell site, UI traffic instead of application data which may utilize varying bandwidths depending on the application types (e.g., media streaming, mobile gaming, social networking, etc.).

Further, moving execution of user applications (e.g., the intelligence or heavy computations) from a UE to an edge server, there is no need to continually upgrade UEs (the physical hardware of the UEs) to higher-performance UEs. The upgrade can be performed at the edge servers by launching an instance of a VM with more resources (e.g., computing resources, memory resources, storage resources, network resources, etc.).

While the present disclosure is described in the context of utilizing VMs at edge server(s) to execute user applications of UEs, at least some user applications of the UEs can be executed using pods or containers on edge server(s). Pods and containers may differ from VMs in that no OS is included in a pod or a container. That is, pods and containers (which are software code objects) may include user applications without an OS.

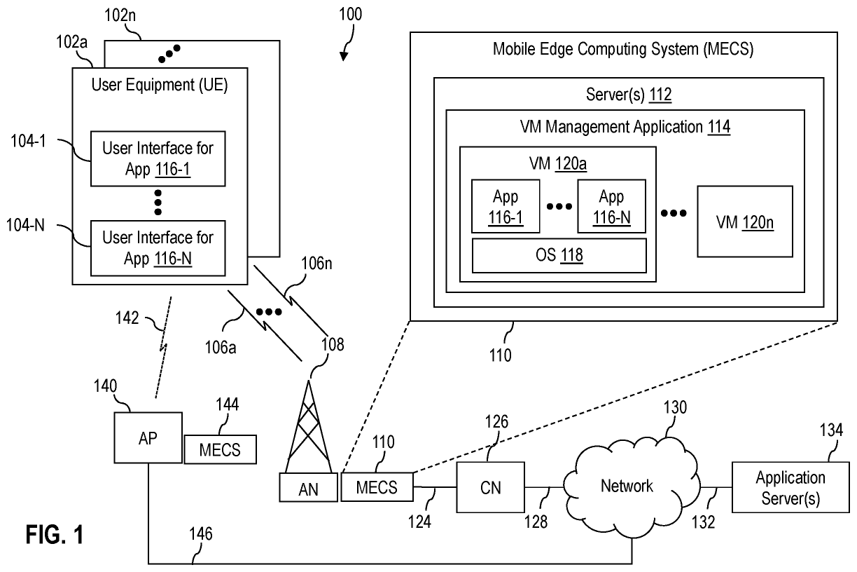

Turning now to FIG. 1, a communication system 100 is described. In an embodiment, system 100 includes a plurality of UEs 102 (shown as 102a, . . . , 102n), a cell site 108, an MECS 110, a CN 126, and a network 130, and one or more application servers 134. A UE 102 may be a cell phone, a mobile phone, a smart phone, a personal digital assistant (PDA), an Internet of things (loT) device, a wearable computer, a headset computer, a laptop computer, a tablet computer, a notebook computer, embedded wireless modules, and/or other wirelessly equipped communication devices (whether or not user operated). In certain examples, a UE 102 may be a wearable computer embedded in or in the form of a wearable goggle, a wearable eyeglass, or a wearable headset.

The cell site 108 may be an AN. The cell site 108 may establish wireless communication links 106 (shown as 106a, . . . , 106n) with the UEs 102 for communication. The cell site 108 providing wireless communications to the UEs 102 may form an access network, which may be referred to as a radio access network in some context. In some examples, the wireless communication links 106 may be established according to a 5G, a long-term evolution (LTE), a code division multiple access (CDMA), a global system for mobile communications (GSM) wireless telecommunication protocol, or some other suitable cellular communication protocol. In 5G technology, an AN may be referred to as a next Generation Node B (gNB). In LTE technology, an AN may be referred to as an evolved Node B (eNB). In CDMA and GSM technology, an AN may be referred to as a base transceiver station (BTS) combined with a base station controller (BSC). In some contexts, an AN may be referred to as a cell tower. The MECS 110 may be co-located with the AN at the cell site 108 or at least near the AN. The MECS 110 may include one or more servers performing remote computations (e.g., in real time) for the UEs 102.

The CN 126 may be coupled to the cell site 108 and/or the MECS 110 via a backhaul link 124 (e.g., a wired link such as a copper link or a fiber link). The CN 126 may provide various network functions, such as access and security management, subscriber authentication, quality of service management, routing and communication control, interconnection with other networks. The network 130 may be coupled to the CN 126 via a communication link 128 (e.g., a wired link such as a copper link or a fiber link). The network 130 may include one or more public networks, one or more private networks, or a combination thereof. The one or more application servers 134 may be coupled to the network 130. The one or more application servers 134 may provide application services to the UEs 102 via the network 130, the CN 126, and the cell site 108. Examples of application services may include, but are not limited to, media streaming, mobile gaming, patient monitoring, machine control, industrial automation, and social networking, AR applications, VR applications, and XR applications. The one or more application servers 134 may provide those application services by executing respective server applications. In some examples, an application server 134 may be coupled to the CN 126 via a communication link (e.g., a wired link such as a copper link or a fiber link) instead of the network 130, for example, to move a producer of information or an application service closer to the end user. In such examples, the application server 134 may provide application services to the UEs 102 via the CN 126 and the cell site 108. While network 130 is shown as separate from the CN 126, and the application server 134 in FIG. 1, it should be appreciated that in some embodiments, the network 130 may include the CN 126, the application server 134, and/or the MEC 110.

In embodiments, the UE 102a may operate as a “dumb terminal”, offloading computations or “intelligence” to the MECS 110. For instance, the UE 102a may include at least one processor and a memory (e.g., a non-transitory memory). The memory may store a plurality of UI applications 104 (shown as 104-1, . . . , 104-N), each including instructions, which when executed by the at least one processor, causes the respective UI application 104 to communicate UI traffic with the MECS 110. The UI traffic may include user inputs received from a user of the UE 102a and/or outputs for display at the UE 102a. The MECS 110 at the cell site 108 may execute user applications 116 (shown as 116-1, . . . , 116-N) for the UE 102a, where each user application 116 may be served by one or more respective application servers 134. Each UI application 104 may communicate with a respective user application 116 of the UE 102a. For instance, the MECS 110 may execute a user application 116-1 communicating with a UI application 104-1 at the UE 102a, the MECS 110 may execute a user application 116-N communicating with a UI application 104-N at the UE 102a, and so on. The user applications 116 may perform the intensive computations (e.g., image processing, video processing, addition of augmented objects for AR, etc.) remotely for the respective UEs 102 in real-time to generate outputs and transmit the outputs (e.g., UI traffic) to the respective UEs 102 for display at respective UI applications 104. For simplicity, FIG. 1 illustrates only UI applications 104 executed on the UE 102a. However, each UE 102 may execute a plurality of UI applications on the respective UE 102 and communicate UI traffic with the MECS 110.

In embodiments, the MECS 110 may be a cloud computing environment including compute resources, memory resources, storage resources. For instance, the MECS 110 may include one or more servers 112 (also referred to herein as “edge servers”) as shown by an expanded view of the MECS 110 in the top right corner of FIG. 1. The MECS 110 (or more specifically the memory resources of the MECS 110) may include a non-transitory memory (e.g., on at least one server 112) storing a VM management application 114. The VM management application 114 may include instructions, when executed by the non-transitory memory, causes the VM management application 114 to launch (or “spin up) and execute instances of VM 120 (shown as 120a, . . . , 120n). Each instance of VM 120 may provide resources (e.g., compute resources, memory resources, and/or storage resources) to host user application(s) for a respective UE 102 that is served by or attached to the cell site 108. For instance, the instance of VM 120a may host user application 116 for the UE 102a and communicate with UI applications 104 at the UE 102a, the instance of VM 120n may host user application(s) for the UE 102n, and so on. Further, each instance of VM 120 may include an OS and the respective user applications may execute on the OS. As shown, the instance of VM 120a may include an OS 118, where the user applications 116 of the UE 102a may be executed on the OS 118. In some examples, an instance of a VM 120 may be executed on one server 112. In other examples, an instance of a VM 120 may be executed on multiple servers. In general, the MECS 110 may allocate resources (e.g., compute resources, memory resources, and/or storage resources) from any suitable number of servers 112 for an instance of a VM 120.

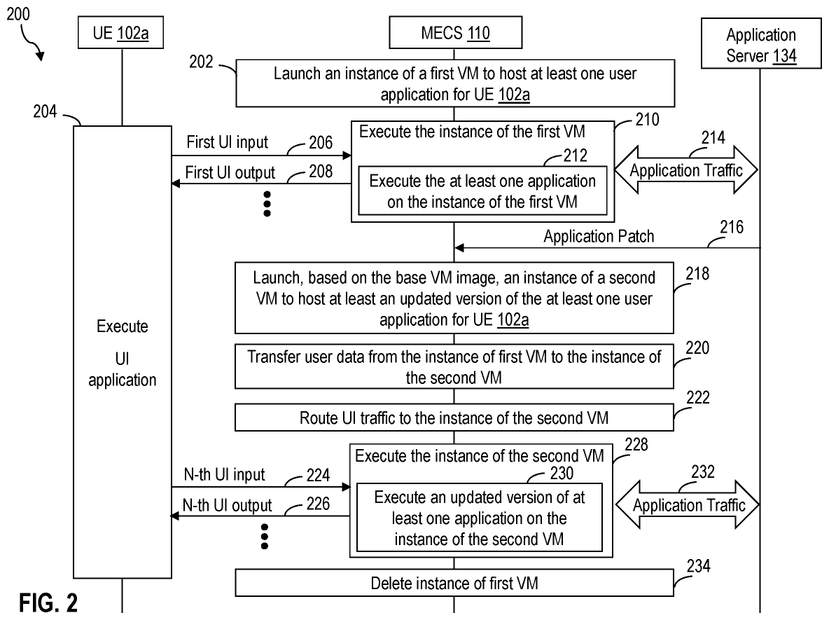

Examples of computing resources may include central processing unit (CPU) cores, graphical processing unit (GPU) cores, or any suitable processing units. An example of memory resources may be RAMs. Examples of storage resources may include disk drives or any storage devices. Further, the VM instances 120 for different UEs may have the same amount of resources or different amount of resources. With user applications (e.g., the user applications 116) of a UE 102 being executed on the MECS 110 instead of at the respective UE 102, software update or application patches for those user applications can be applied at the MECS 110 rather than having to download application patches via the cell site 108 to the respective UE 102, and thus may reduce network traffic. When there is a large number of UEs served by cell site 108 requiring an application layer software update, the savings in network traffic can be significant. Mechanisms for executing user applications for a UE on the MECS 110 in accordance with the embodiments disclosed herein will be discussed more fully below with reference to FIGS. 2, 3, and 5.

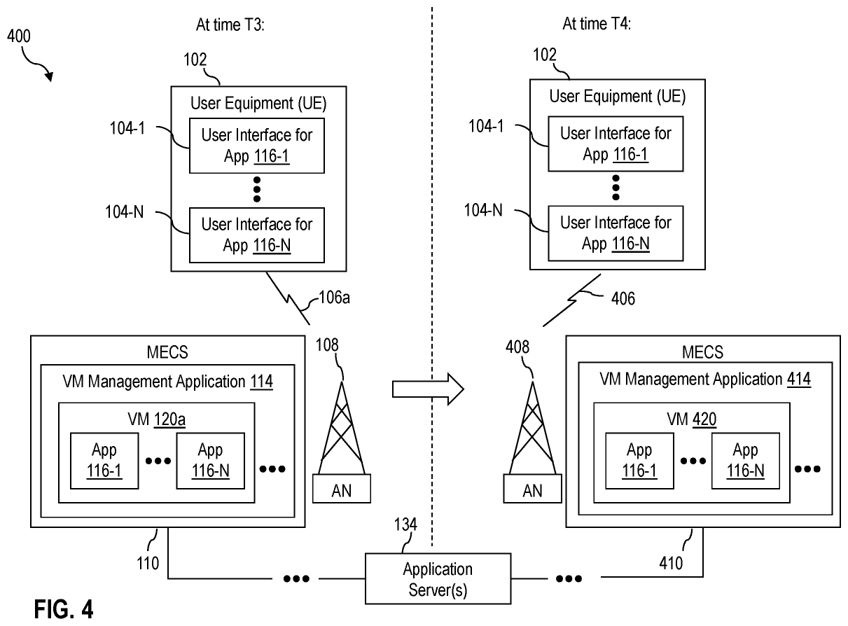

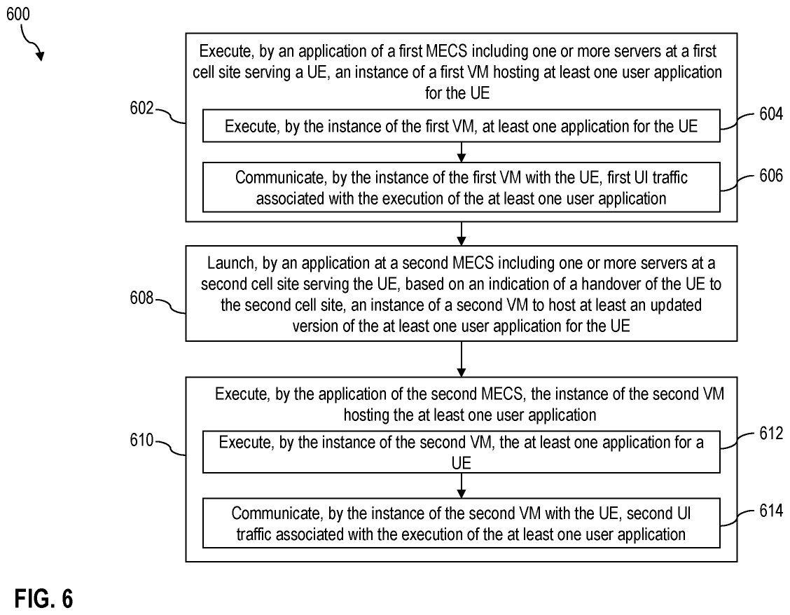

While FIG. 1 illustrates one cell site 108, the communication system 100 may include more than one cell site 108 (e.g., 2, 3, 4, 5 or more) providing coverage over various geographical areas and an MECS similar to the MECS 110 may be co-located with each cell site. In some examples, a UE 102 may travel from one geographical area served by one cell site to another geographical area served by another cell site. Mechanisms for executing user applications for a UE on MECSs with hand off of real-time remote computations for a UE transitioning between cell sites (or base stations) will be discussed more fully below with reference to FIGS. 4 and 6.

As further shown in FIG. 1, the communication system 100 may include an AP 140 and an MECS 144 co-located with the AP 140. In an example, the UE 102a may be connected to or served by the cell site 108 at one time and connected to or served by the AP 140 at another time. The AP 140 may communicate with the UE 102a via a local wireless connection 142 as shown by the dotted line. In some examples, the local wireless connection 142 may be any suitable Institute of IEEE 802.11 connection. In the illustrated example of FIG. 1, the AP 140 may be connected to the network 130 via a communication link 146 (e.g., a copper link or a fiber link) without connecting to the CN 126 and further connected to the one or more application server(s) 134 via the network 130. In other examples, the AP 140 may be connected to the network 130 via a wireless network (e.g., similar to the cell site 108) and a CN 126.

The MECS 144 may be substantially similar to the MECS 110. For instance, the MECS 144 may include resources that can be used to execute user applications for UEs in communication with the AP 140. However, instead of having a bank of servers as in the MECS 110, the MECS 144 may include one or more computing devices. Further, in some instances, the AP 140 may be located at a home of a user of a UE, and the MECS 144 may be a home computer. In other instances, the AP 140 may be located at a business or commercial location, and the MECS 144 may include multiple computers. In embodiments, when the UE 102a is in communication with the AP 140, the MECS 144 co-located with the AP 140 may execute the user applications 116 of the UE 102a using substantially similar mechanisms as discussed above.

In embodiments, the UEs 102 may be a reduced-capability UE since the UEs 102 offloads the execution of user applications (e.g., the user applications 116) to the MECS 110 or 144. A reduced-capability UE may include a memory storing UI applications 104, at least one processor configured to execute the instructions of the UI applications 104, a touch screen coupled to the at least one process and configured for interactions with the UI applications 104 (e.g., to receive a user input and display output), a microphone, a speaker, and/or a radio transceiver for communicating wireless communication signals with the cell site 108. In some examples, a reduced-capability UE (e.g., Internet-of-things loT devices) may not include a touch screen. Because the reduced-capability UE offloads execution of user applications to the MECS 110, the reduced-capability UE may utilize a lower-performance processor and a smaller memory than a full-capability UE that is capable of executing all user applications on the UE. As such, the reduced-capability UE may have a lower power consumption and/or a lower cost than a full-capability UE. In some examples, the reduced-capability may have a battery that is charged by harvesting at least some power from an RF signal transmitted by the cell site 108, for example, over the wireless communication links 106. In general, the reduced-capability UE may include other components, such as a radio transceiver, a headset interface and port, a universal serial bus (USB) interface and port, a camera, a global positioning system (GPS), etc., as a full-capability UE.

FIGS. 2-7 may be discussed in connection with FIG. 1 to illustrate mechanisms for performing user device real-time remote computation.

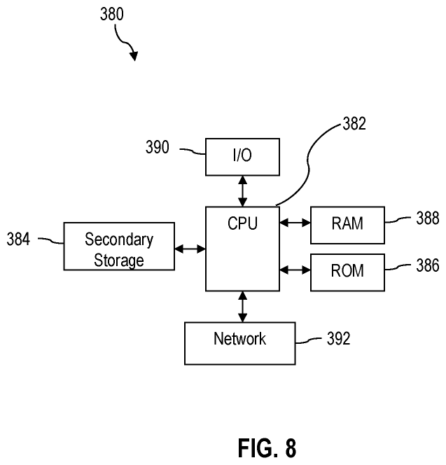

Turning now to FIG. 2, a user device real-time remote computation method 200 with a software update is described. The software update may refer to the updating of an application software providing real-time remote computations for a UE 102. The method 200 illustrates operations performed by various components of the communication system 100. Specifically, the components include the UE 102a, the MECS 110, and the application server 134. However, it is contemplated that other component(s) of the communication system 100 may be involved in performing the operations of the method 200. For instance, the MECS 110 may be co-located with a cell site (e.g., the cell site 108) serving the UE 102a and signals communicated between the UE 102a and the MECS 110 may be via the serving cell site of the UE 102a. Further, the MECS 110 may be coupled to a CN (e.g., the CN 126) and/or a network (e.g., the network 130) and signals communicated between the MECS 110 and the application server 134 may be via the CN and/or the network. In embodiments, each of the UE 102a, the MECS 110, and the application server 134 may implement the operations of the method 200 using a computer system with components as shown in FIG. 8. As illustrated, FIG. 2 includes a number of enumerated operations, but embodiments of the operations in FIG. 2 may include additional operations before, after, and in between the enumerated operations. In some embodiments, one or more of the enumerated operations may be omitted or performed in a different order. While FIG. 2 is discussed in the context of the MECS 110, the operations of the MECS 110 can be performed by the MECS 144 of FIG. 1 instead, for example, when the UE 102a communicates with the AP 140 instead of the cell site 108.

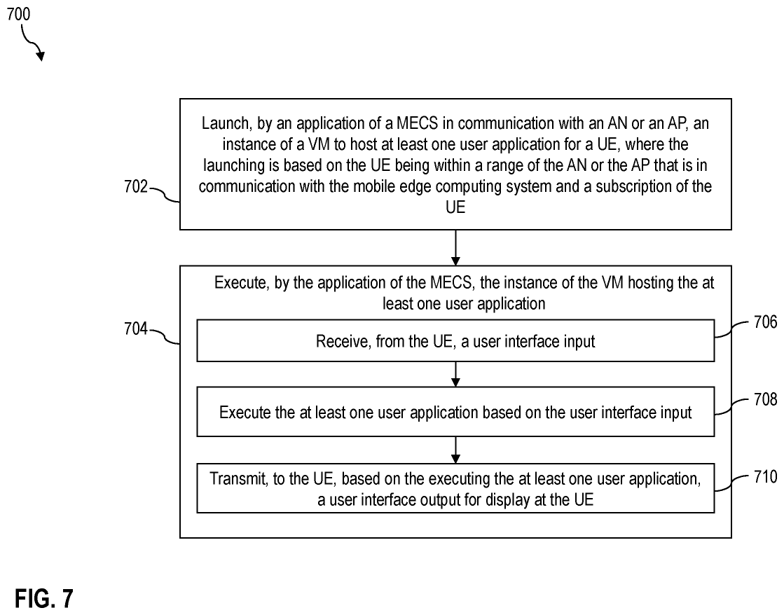

At operation 202, an application (e.g., the VM management application 114) of the MECS 110 may launch an instance of a first VM (e.g., the instance of the VM 120a) to host at least one user application (e.g., the user application 116-1) for the UE. In an example, as part of the launching, the application of the MECS 110 may select the first VM from a template of VMs and spin up an instance of the selected VM on one or more servers (e.g., the server(s) 112) of the MECS 110. Each VMs in the template may have a certain resource capacity, memory capacity, and/or storage capacity. As an example, the first VM may include one CPU core, two GPU cores, 32 gigabytes (GB) of RAM, and 256 GB of disk storage, and another VM in the template may include one CPU core, one GPU core, 16 GB of RAM, and 256 GB of disk storage. The application of the MECS may launch the instance of the first VM based on the resource availability of the first VM matching or satisfying a resource requirement for hosting the at least one user application of the UE 102a. In other words, as part of launching the instance of the first VM, the application of the MECS may allocate resources from the MECS for execution of the instance of the first VM. In embodiments, the application of the MECS 110 may select the first VM from the template based on a subscription of the UE 102a as will be discussed more fully below with reference to FIG. 7.

At operation 204, the UE 102a may execute a UI application (e.g., the UI application 104-1). The UI application may receive user inputs from a user of the UE 102a and may display outputs (e.g., in the form of a graphical representation) according to an execution of the at least one user application.

At operation 210, the application of the MECS 110 may execute the instance of the first VM hosting the at least one user application for the UE 102a. At operation 212, as part of executing the instance of the first VM, the instance of the first VM may execute the at least one user application and communicate first UI traffic related to the at least one user application with the UE 102a. For instance, the first UI traffic may include a first UI input and a first UI output. As shown, at operation 206, the UI application of the UE 102a may transmit the first UI input to the MECS 110 and the MECS 110 may route the first UI input to the instance of the first VM. At operation 208, the execution of the at least one user application on the instance of the first VM may generate the first UI output, and the MECS 110 may transmit the first UI output to the UE 102a for display (at the UI application of the UE 102a). The execution of the at least one user application may continue with generating a second UI output, a third UI output, a fourth UI output, and so on, and the MECS 110 may transmit the second UI output, the third UI output, the fourth UI output, and so on to the UE 102a for display (at the UI application of the UE 102a). In some examples, the UI application of the UE 102a may further transmit one or more UI inputs to the MECS 110, and the MECS 110 may route the one or more UI inputs to the instance of the first VM. The instance of the first VM may execute the at least one user application based on the one or more UI inputs.

As an example, the at least one user application may be a video streaming application. A user of the UE 102a may select a certain video content for streaming via a user input. Instead of performing intensive image computations for video streaming at the UE 102a, these intensive image computations are performed by the instance of the first VM using resources of the one or more servers of the MECS 110. Thus, the UI output communicated by the instance of the first VM may be pixels (e.g., in the RGB format) that have changed since the last display at the UE.

As another example, the at least one user application may be a mobile gaming application. A user of the UE 102a may perform various actions (e.g., as an avatar traveling in the gaming environment) via user inputs. Instead of performing intensive graphical computations at the UE 102a to update a surrounding of the gaming environment UE 102a, these intensive graphical computations are performed by the instance of the first VM using resources of the one or more servers of the MECS 110. Thus, similar to the video streaming example, the UI output communicated by the instance of the first VM may be pixels that have changed since the last display at the UE.

As yet another example, the at least one user application may be an AR application (e.g., for gaming, entertainment, medical related operations, etc.). Image(s) may be captured at the UE 102a for the AR purpose. Instead of performing intensive processing of the image(s) and adding augmented components at the UE 102a, the image(s) may be streamed from the UE 102a to the first VM instance. The at least one user application may be executed remotely at the first VM instance to process the image(s) and add augmented components to the image(s). The first VM instance may send the augmentations back to the UE 102a for overlay (e.g., onto a display of the UE 102a, which may be glasses or goggles). Alternatively, the first VM may send the augmented images back to the UE 102a for display.

In some instances, the instance of the first VM may execute the at least one user application according to a user configuration (e.g., application settings or preferences) of the UE. Further, user data (e.g., photo images, videos, data files, etc.) of the UE may be stored on the instance of the first VM. In some instances, the execution of the at least one user application may utilize at least some of the stored user data. As an example, the user data may include a photo image, and the at least one user application may be a photo editing application that can be used to modify the photo image.

At operation 214, the application of the MECS 110 may communicate application traffic with the application server 134. Referring to the video streaming application example, the application traffic may include video data or content served by the application server 134, and the execution of the at least one user application on the instance of the first VM may be based on the video data received from the application server 134.

At operation 216, the application of MECS 110 may receive an application patch for updating the at least one user application.

Under a normal operating condition, the application of the MECS 110 may receive the application patch from the application server 134 via a backhaul link (e.g., the backhaul link 124) that couples a cell site to a CN (e.g., the CN 126). If, however, there is a fault at the backhaul link during the software update, the application of the MECS 110 may receive at least a portion of the application patch via a LOS link from another cell site (e.g., a second cell site). The second cell site may be coupled to the same the CN as the cell site at which the MECS 110 is located or a different CN coupled to the application server 134. As such, the application of the MECS 110 may receive at least a portion of the application patch from the application server 134 via the other cell site and a respective CN coupling the other cell site to the application server 134.

At operation 218, in response to receiving the application patch, the application of the MECS 110 may launch an instance of a second VM (e.g., a new VM instance) to host at least an updated version of the at least one user application for the UE 102a, where the updated version of the at least one user application includes the application patch. In an example, the application of the MECS 110 may replicate or copy an image of the first VM and apply the application patch to the replicated VM image. That is, the instance of the first VM and the instance of the second VM may have the same resource configuration (e.g., the same amount of computing, memory, and storage resources) and may have the same OS and the same set of user application(s) including the at least one user application installed. However, the instance of the second VM may be installed with the updated version of the at least one user application, for example, in the form of a library including the updated version of the at least one user application.

At operation 220, the application of the MECS 110 may transfer the user data and/or the user configuration of the UE 102a from the instance of the first VM to the instance of the second VM.

At operation 222, the application of the MECS 110 may route UI traffic of the UE 102a to the instance of the second VM.

At operation 228, the application of the MECS 110 may execute the instance of the second VM hosting at least the updated version of the at least one user application for the UE 102a. At operation 230, as part of executing the instance of the second VM, the instance of the second VM may execute the updated version of the at least one user application and communicate, with the UE, N-th UI traffic related to the updated version of the at least one user application. For instance, the N-th UI traffic may include an N-th UI input and an N-th UI output. As shown, at operation 224, the UI application of the UE 102a may transmit the N-th UI input to the MECS 110, and the MECS 110 may route the N-th UI input to the instance of the second VM. The execution of the at least one user application on the instance of the second VM at operation 230 may generate the N-th UI output, and the MECS 110 may transmit the N-th UI output to the UE 102a.

At operation 232, the application of the MECS 110 may communicate application traffic with the application server 134. The application traffic communicated at operation 232 may include data served by the application server 134, and the execution of the at least one user application on the instance of the second VM may be based on the data received from the application server 134.

At operation 234, after the application of the MECS 110 started to execute the instance of the second VM, the application of the MECS 110 may delete (or “kill”) the instance of the first VM. The deletion of the instance of the first VM may release all resources (e.g., computing, memory, and storage resources) that were allocated to the instance of the first VM.

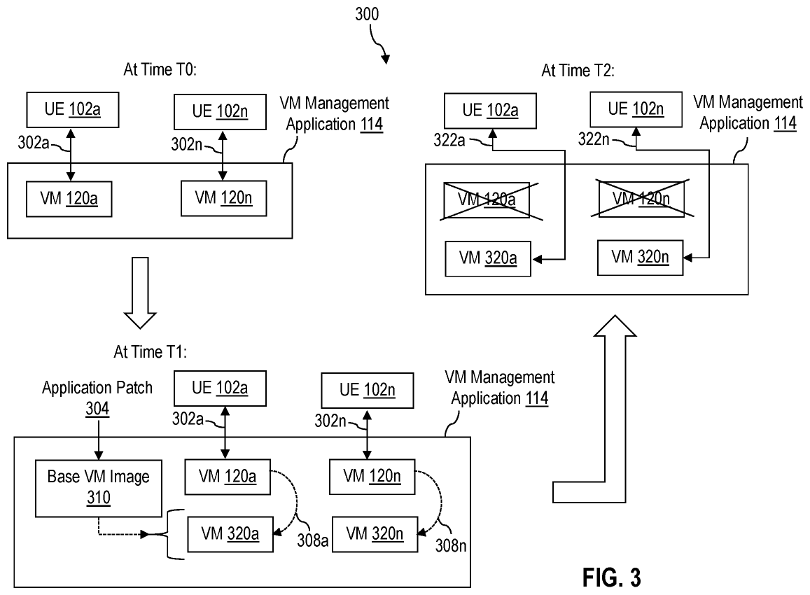

Turning now to FIG. 3, a user device real-time remote computation method 300 with region-specific or cell site-specific software update is described. The software update may refer to the updating of an application software providing real-time remote computations for a UE 102. The method 300 may be implemented by the VM management application 114 implemented on the MECS 110 of FIG. 1 or on the MECS 144 of FIG. 1. The method 300 may include similar mechanisms as discussed above with reference to FIGS. 1-2. The method 300 further illustrates a global software update for UEs in a certain region and/or served by a certain cell site. For simplicity, FIG. 3 illustrates a software update for two UEs (the UE 102a and the UE 102n). However, the method 300 may be applied to update software for any suitable number of UEs (e.g., 3, 4, 5, 6, 7, 8 or more).

As shown in FIG. 3, at time T0, the VM management application 114 may launch and execute an instance of a VM 120a to host user application(s) (e.g., the user applications 116) for the UE 102a. The VM management application 114 may further launch and execute an instance of a VM 120n to host user application(s) (e.g., the user applications 116) for the UE 102n. The execution of the instance of the VM 120a may include executing the user applications of the UE 102a and communicating UI traffic 302a with the UE 102a using substantially similar mechanisms as discussed above with reference to FIG. 2. The execution of the instance of the VM 120n may include executing the user applications of the UE 102n and communicating UI traffic 302n with the UE 102n as for the UE 102a.

In embodiments, the instance of the VM 120a and instance of the VM 120n may be instantiated or created from the same VM image. That is, the instance of the VM 120a and the instance of the VM 120n may execute the same set of user applications (e.g., standard user applications for a certain UE model or UE version). However, the user applications on the instance of the VM 120a may be configured based on a user configuration (e.g., application settings and/or preferences) set by a user of the UE 102a, and the user applications on the instance of the VM 120n may be configured based on a user configuration (e.g., application settings and/or preferences) set by a user of the UE 102n. Additionally, the instance of the VM 120a may include storage resources storing user data (e.g., photos, videos, etc.) of the UE 102a, and the instance of the VM 120n may include storage resources storing user data (e.g., photos, videos, etc.) of the UE 102n.

At time T1, the VM management application 114 may receive an application patch 304, for example, from the application server 134 of FIG. 1. The application patch 304 may be used for updating a first user application for the UE 102a and the same first user application for the UE 102n. In some examples, the application patch 304 may be in the form of a binary executable. In response to receiving the application patch 304, the VM management application 114 may create a base VM image 310 by replicating or making a copy of the VM image used for creating the instance of the VM 120a and the instance of the VM 120n and applying the application patch 304 to the replicated VM image. In an example, the replicated VM image may be a software code object and the application patch 304 may be applied by executing an installation script to install the application patch 304 onto the replicated VM image.

The VM management application 114 may create (launch or instantiate), from the base VM image 310, an instance of a VM 320a to host an updated version of the first user application and remaining user applications in the set of user applications for the UE 102a. Similarly, the VM management application 114 may create (launch or instantiate), from the base VM image 310, an instance of a VM 320n to host an updated version of the first user application and remaining user applications in the set of user applications for the UE 102n.

The VM management application 114 may transfer the user configuration and the user data of the UE 102a from the instance of the VM 120a to the VM 320a as shown by the dotted arrow 308a. In a similar way, the VM management application 114 may transfer the user configuration and the user data of the UE 102n from the instance of the VM 120n to the VM 320n as shown by the dotted arrow 308n.

At time T2, the VM management application 114 may execute the instance of the VM 320a to host the user applications including the updated version of the first user application for the UE 102a based on the user configuration and/or the user data of the UE 102a. In a similar way, the VM management application 114 may execute the instance of the VM 320n to host the user applications including the updated version of the first user application for the UE 102n based on the user configuration and/or the user data of the UE 102n. The VM management application 114 may further route UI traffic 322a from the UE 102a to the instance of the VM 320a and route UI traffic 322n from the UE 102n to the instance of the VM 320n. After the instance of the VM 320a and the instance of the VM 320n becomes live (or active), the VM management application 114 may delete (or kill) the instance of the VM 120a and the instance of the VM 120n as shown by the “X” marks.

In other embodiments, each of the set of user applications executed for the UE 102a on the instance of the VM 120a and the set of user applications executed for the UE 102n on the instance of the VM 120n may include the first user application but may include a different combination of user applications. In such embodiments, the VM management application 114 may create the instance of the VM 320a by replicating a first VM image used for creating the instance of the VM 120a and apply the application patch 304 to the replicated first VM image. In a similar way, the VM management application 114 may create the instance of the VM 320n by replicating a second VM image used for creating the instance of the VM 120n and apply the application patch 304 to the replicated second VM image.

Turning now to FIG. 4, a user device real-time remote computation scenario 400 with hand off of real-time remote computations for a mobile UE (e.g., transitioning from one base station or cell site to another base station or cell site) is described. As shown in FIG. 4, at time T3, the VM management application 114 of the MECS 110 may execute the instance of the VM 120a to host user applications (e.g., the user applications 116-1, . . . , 116-N) for the UE 102a while the UE 102a is served by the cell site 108 (via the wireless communication link 106a). As part of executing the instance of the VM 120a, the instance of the VM 120a may execute each user application 116 and communicate UI traffic with a respective UI application 104 over the wireless communication link 106a. The execution of the user applications 116 may be based on application data served by the application server(s) 134, for example, via a CN 126 and a network 130 as shown in FIG. 1. The execution of the user applications 116 may be further based on a user configuration (e.g., including application settings and preferences for the user applications 116) and/or user data of the UE 102a.

At time T4, the UE 102a may travel to an area that is out of the coverage of the cell site 108 but may be served by a different cell site 408. That is, the UE 102a may be handed over from the cell site 108 to the cell site 408. The cell site 408 may be substantially similar to the cell site 108. An MECS 410 substantially similar to the MECS 110 may be co-located with the cell site 408. For instance, the MECS 410 may include one or more servers executing a VM management application 414. Upon the VM management application 414 receiving an indication of a handover of the UE 102a to the cell site 408, the VM management application 414 may launch an instance of a VM 420 to host the user applications 116 of the UE 102a. Further, the VM management application 114 may transfer the user configuration and the user data of the UE 102a from the MECS 110 to the MECS 410 in response to the indication of the handover.

Subsequently, the VM management application 414 of the MECS 410 may execute the instance of the VM 420 hosting the user applications 116 for the UE 102a based on the user configuration and/or the user data of the UE. As part of executing the instance of the VM 420, the instance of the VM 420 may execute each user application 116 and communicate UI traffic with a respective UI application 104 over the wireless communication link 406. The execution of the user applications 116 on the instance of the VM 420 may be based on application data served by the application server(s), for example, via a CN 126 and a network 130 as shown in FIG. 1. In another example, the MECS 410 may be coupled to the application server(s) 134 via a different CN than the CN 126. In yet another example, the MECS 410 may be coupled to application server(s) different than the application server(s) 134. For instance, a certain application service provider may deploy application server(s) in distributed locations, closer to end users, where the application server(s) at the distributed locations may serve the same content (e.g., application data).

While FIG. 4 illustrates a handover of a UE from one cell site to another cell site, aspects are not limited thereto. For example, in some instances, a UE can be handed over from the cell site to an AP similar to the AP 140 of FIG. 1. As such, a MECS similar to the MECS 144 of FIG. 1 communicatively coupled to the AP may launch and execute an instance of a VM to host user applications of the UE after the handover. In other instances, a UE can be handed over from an AP similar to the AP 140 of FIG. 1 to a cell site. As such, a MECS similar to the MECS 144 of FIG. 1 communicatively coupled to the AP may launch and execute an instance of a VM to host user applications of the UE before the handover. In general, a UE may offload intensive computations to any suitable edge servers of a carrier network and/or APs in a WiFi network for remote real-time computations, for example, based on traffic or loads and not necessarily as tightly tied to geography.

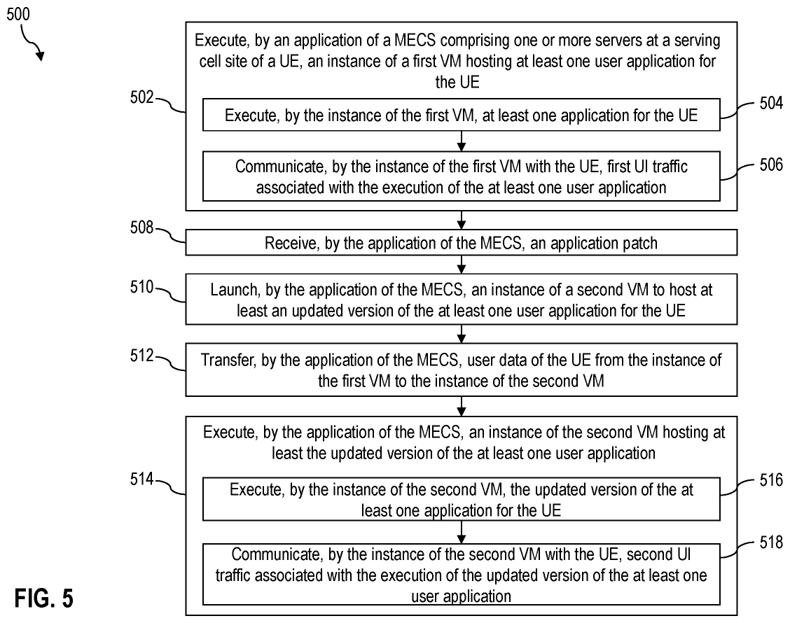

Turning now to FIG. 5, a method 500 is described. In an embodiment, the method 500 is a method of performing user device remote computation with software update. The software update may refer to the updating of an application software providing real-time remote computations for a UE 102. The method 500 may include similar mechanisms as discussed above with reference to FIGS. 1-4. In embodiments, the method 500 may be implemented using a computer system with components as shown in FIG. 8. As illustrated, FIG. 5 includes a number of enumerated operations, but embodiments of the operations in FIG. 5 may include additional operations before, after, and in between the enumerated operations. In some embodiments, one or more of the enumerated operations may be omitted or performed in a different order.

At block 502, an application at an MECS including one or more servers at a serving cell site of the UE executes an instance of a first VM hosting at least one user application for the UE. In an example, the MECS may be similar to the MECS 110 or 410, the application of the MECS may be similar to the VM management application 114 or 414, the instance of the first VM may be similar to the VM instance 120a, 120n, 320a, 320n, the UE may be similar to the UE 102a or 102n, and the at least one user application may be similar to the user application 116a or 116n. As part of executing the instance of the first VM, the instance of the first VM performs operations of blocks 504 and 506. At block 504, the instance of the first VM executes the at least one user application. At block 506, the instance of the first VM communicates, with the UE, first UI traffic associated with execution of the at least one user application.

At block 508, the application of the MECS receives an application patch for updating the at least one user application. At block 510, in response to receiving the application patch, the application of the MECS launches an instance of a second VM (e.g., a new VM instance) to host at least an updated version of the at least one user application for the UE, where the updated version of the at least one user application includes the application patch. In an example, the instance of the first VM may be similar to the VM instance 120a, 120n, 320a, 320n.

At block 512, the application of the MECS transfers user data of the UE from the instance of the first VM to the instance of the second VM. At block 514, the application of the MECS executes the instance of the second VM hosting at least the updated version of the at least one user application for the UE. As part of executing the instance of the second VM, the instance of the second VM performs operations of blocks 516 and 518. At block 516, the instance of the second VM executes the updated version of the at least one user application. At block 518, the instance of the second VM communicates, with the UE, second UI traffic associated with the execution of the updated version of the at least one user application.

In embodiments, the launching the instance of the second VM at block 510 is further based on a base VM image including the updated version of the at least one user application. In embodiments, the application of the MECS further builds the base VM image based on a VM of the first VM and the application patch. In embodiments, the application patch is a common application patch for a plurality of UEs located in a specific geographical region or associated with a specific cell site. In embodiments, the application of the MECS further launches, based on the base VM image, an instance of a third VM to host at least the updated version of the at least one user application for another UE served by the serving cell site of the UE, for example, as discussed above with reference to FIG. 3.

In embodiments, as part of receiving the application patch at block 508, the application of the MECS may receive the application patch via a backhaul link (e.g., the link 124).

In embodiments, as part of receiving the application patch at block 508, the application of the MECS may receive at least a portion of the application patch from another cell site via an LOS link (e.g., a wireless communication link in a direct path between the other cell site and the cell site at which the MECS is co-located). In embodiments, the receiving the application patch from the other cell site via the LOS link is further in response to a fault at a backhaul link coupled to the MECS.

In embodiments, the application of the MECS further deletes the instance of the first VM hosting the at least one user application for the UE and routes the second UI traffic of the UE to the instance of the second VM in response to deleting the instance of the first VM. The deletion of the instance of the first VM may release all resources (e.g., computing, memory, and storage resources) that were allocated to the instance of the first VM.

In embodiments, the application of the MECS launches, based on a user configuration of the UE, the instance of the first VM to host the at least one user application for the UE, where the launching the instance of the second VM to host the updated version of the at least one user application for the UE at block 510 is further based on the user configuration of the UE.

Turning now to FIG. 6, a method 600 is described. In an embodiment, the method 600 is a method of performing user device remote computation with hand off of real-time remote computations for a mobile UE. The method 600 may include similar mechanisms as discussed above with reference to FIGS. 1-5. In embodiments, the method 600 may be implemented using a computer system with components as shown in FIG. 8. As illustrated, FIG. 6 includes a number of enumerated operations, but embodiments of the operations in FIG. 6 may include additional operations before, after, and in between the enumerated operations. In some embodiments, one or more of the enumerated operations may be omitted or performed in a different order.

At block 602, an application of a first MECS including one or more first servers at a first cell site serving the UE executes an instance of a first VM. The instance of the first VM hosts at least one user application for the UE based on at least one of a user configuration or user data of the UE. In an example, the first MECS may be similar to the MECS 110 or 410, the application of the first MECS may be similar to the VM management application 114 or 414, the instance of the first VM may be similar to the VM instance 120a, 120n, 320a, 320n, the UE may be similar to the UE 102a or 102n, and the at least one user application may be similar to the user application 116a or 116n. As part of executing the instance of the first VM, the instance of the first VM performs operations of blocks 604 and 606. At block 604, the instance of the first VM executes the at least one user application. At block 606, the instance of the first VM communicates, with the UE, first UI traffic associated with the execution of the at least one user application on the instance of the first VM.

At block 608, the application of a second MECS including one or more servers at a second cell site launches, based on an indication of a handover of the UE to the second cell site, an instance of a second VM to host the at least one user application for the UE. In embodiments, the launching the instance of the second VM is further based on location information of the UE. For instance, the location information may be computed by the second cell site and/or the second MECS, for example, based on beamforming information and/or round-trip-delay information from communication with the UE. In other examples, the handover indication may be received from the first cell site or a CN coupled to the first cell site and/or the second cell site.

At block 610, the second MECS executes the instance of the second VM hosting the at least one user application for the UE based on the at least one of the user configuration or the user data of the UE. As part of executing the instance of the second VM, the instance of the second VM performs operations of blocks 612 and 614. At block 612, the instance of the second VM executes the at least one user application. At block 614, the instance of the second VM communicates, with the UE, second UI traffic associated with the execution of the at least one user application.

In embodiments, the application of the first MECS further transfers, based on the indication of the handover of the UE to the second MECS, the at least one of the user configuration or the user data of the UE to the second MECS.

In embodiments, the executing the instance of the first VM at block 602 and the executing the instance of the second VM at block 610 are associated with the same terminal session of the UE.

Turning now to FIG. 7, a method 700 is described. In an embodiment, the method 700 is a method of performing user device remote computation based on a subscription of a UE. The method 700 may include similar mechanisms as discussed above with reference to FIGS. 1-6. In embodiments, the method 700 may be implemented using a computer system with components as shown in FIG. 8. As illustrated, FIG. 7 includes a number of enumerated operations, but embodiments of the operations in FIG. 7 may include additional operations before, after, and in between the enumerated operations. In some embodiments, one or more of the enumerated operations may be omitted or performed in a different order.

At block 702, an application of an MECS communicatively coupled to an AN or an AP launches an instance of a VM to host at least one user application for a UE. In an example, the AN may be similar to the cell sites 108 or 408, the AP may similar to the AP 140, the MECS may be similar to the MECS 110, 144, or 410, the application of the MECS may be similar to the VM management application 114 or 414, the instance of the VM may be similar to the VM instance 120a, 120n, 320a, 320n, the UE may be similar to the UE 102a or 102n, and the at least one user application may be similar to the user application 116a or 116n. The launching is based on the UE being within a range of the AN or AP that is in communication with the MECS and a subscription of the UE.

At block 704, the application of the MECS executes the instance of the VM hosting the at least one user application for the UE. As part of executing the instance of the VM, the instance of the VM performs operations of blocks 706, 708, and 710. At block 706, the instance of the VM receives, from the UE, a UI input. At block 708, the instance of the VM executes the at least one user application based on the UI input. At block 710, the instance of the VM transmits, to the UE, based on the executing the at least one user application, a UI output for display at the UE.

In embodiments, the launching the instance of the VM to host the at least one application for the UE at block 702 is further based on a resource availability of the VM satisfying a resource requirement associated with a subscription level of the UE. For instance, the subscription may define a level of resources (e.g., computing resources, memory resources, storage resources, bandwidth, etc.) that is to be provided to the UE for remote real-time computations, where different subscription levels may be associated with different subscription costs.

In embodiments, the application of the MECS further determines, based on a characteristic (e.g., an application type) of the at least one user application for the UE, at least one of a computing resource requirement or a memory resource requirement for hosting the at least one user application for the UE, and the launching the instance of the VM to host the at least one application for the UE at block 702 is further based on a resource availability of the VM satisfying the at least one of the determined computing resource requirement or the memory resource requirement. For instance, the subscription of the UE may be based on a pay-as-you-go subscription pricing model.

In embodiments, the launching the instance of the VM to host the at least one application for the UE at block 702 is further based on a timer period specified by the subscription of the UE.

FIG. 8 illustrates a computer system 380 suitable for implementing one or more embodiments disclosed herein. The computer system 380 includes a processor 382 (which may be referred to as a central processor unit or CPU) that is in communication with memory devices including secondary storage 384, read only memory (ROM) 386, RAM 388, input/output (I/O) devices 390, and network connectivity devices 392. The processor 382 may be implemented as one or more CPU chips.

It is understood that by programming and/or loading executable instructions onto the computer system 380, at least one of the CPU 382, the RAM 388, and the ROM 386 are changed, transforming the computer system 380 in part into a particular machine or apparatus having the novel functionality taught by the present disclosure. It is fundamental to the electrical engineering and software engineering arts that functionality that can be implemented by loading executable software into a computer can be converted to a hardware implementation by well-known design rules. Decisions between implementing a concept in software versus hardware typically hinge on considerations of stability of the design and numbers of units to be produced rather than any issues involved in translating from the software domain to the hardware domain. Generally, a design that is still subject to frequent change may be preferred to be implemented in software, because re-spinning a hardware implementation is more expensive than re-spinning a software design. Generally, a design that is stable that will be produced in large volume may be preferred to be implemented in hardware, for example in an application specific integrated circuit (ASIC), because for large production runs the hardware implementation may be less expensive than the software implementation. Often a design may be developed and tested in a software form and later transformed, by well-known design rules, to an equivalent hardware implementation in an ASIC that hardwires the instructions of the software. In the same manner as a machine controlled by a new ASIC is a particular machine or apparatus, likewise a computer that has been programmed and/or loaded with executable instructions may be viewed as a particular machine or apparatus.

Additionally, after the system 380 is turned on or booted, the CPU 382 may execute a computer program or application. For example, the CPU 382 may execute software or firmware stored in the ROM 386 or stored in the RAM 388. In some cases, on boot and/or when the application is initiated, the CPU 382 may copy the application or portions of the application from the secondary storage 384 to the RAM 388 or to memory space within the CPU 382 itself, and the CPU 382 may then execute instructions that the application is comprised of. In some cases, the CPU 382 may copy the application or portions of the application from memory accessed via the network connectivity devices 392 or via the I/O devices 390 to the RAM 388 or to memory space within the CPU 382, and the CPU 382 may then execute instructions that the application is comprised of. During execution, an application may load instructions into the CPU 382, for example load some of the instructions of the application into a cache of the CPU 382. In some contexts, an application that is executed may be said to configure the CPU 382 to do something, e.g., to configure the CPU 382 to perform the function or functions promoted by the subject application. When the CPU 382 is configured in this way by the application, the CPU 382 becomes a specific purpose computer or a specific purpose machine.

The secondary storage 384 is typically comprised of one or more disk drives or tape drives and is used for non-volatile storage of data and as an over-flow data storage device if RAM 388 is not large enough to hold all working data. Secondary storage 384 may be used to store programs which are loaded into RAM 388 when such programs are selected for execution. The ROM 386 is used to store instructions and perhaps data which are read during program execution. ROM 386 is a non-volatile memory device which typically has a small memory capacity relative to the larger memory capacity of secondary storage 384. The RAM 388 is used to store volatile data and perhaps to store instructions. Access to both ROM 386 and RAM 388 is typically faster than to secondary storage 384. The secondary storage 384, the RAM 388, and/or the ROM 386 may be referred to in some contexts as computer readable storage media and/or non-transitory computer readable media.

I/O devices 390 may include printers, video monitors, liquid crystal displays (LCDs), touch screen displays, keyboards, keypads, switches, dials, mice, track balls, voice recognizers, card readers, paper tape readers, or other well-known input devices.

The network connectivity devices 392 may take the form of modems, modem banks, Ethernet cards, USB interface cards, serial interfaces, token ring cards, fiber distributed data interface (FDDI) cards, wireless local area network (WLAN) cards, radio transceiver cards, and/or other well-known network devices. The network connectivity devices 392 may provide wired communication links and/or wireless communication links (e.g., a first network connectivity device 392 may provide a wired communication link and a second network connectivity device 392 may provide a wireless communication link). Wired communication links may be provided in accordance with Ethernet (IEEE 802.3), Internet protocol (IP), time division multiplex (TDM), data over cable service interface specification (DOCSIS), wavelength division multiplexing (WDM), and/or the like. In an embodiment, the radio transceiver cards may provide wireless communication links using protocols such as CDMA, global system for mobile communications (GSM), LTE, WiFi (IEEE 802.11), Bluetooth, Zigbee, narrowband Internet of things (NB loT), near field communications (NFC), and radio frequency identity (RFID). The radio transceiver cards may promote radio communications using 5G, 5G New Radio, or 5G LTE radio communication protocols. These network connectivity devices 392 may enable the processor 382 to communicate with the Internet or one or more intranets. With such a network connection, it is contemplated that the processor 382 might receive information from the network, or might output information to the network in the course of performing the above-described method steps. Such information, which is often represented as a sequence of instructions to be executed using processor 382, may be received from and outputted to the network, for example, in the form of a computer data signal embodied in a carrier wave.

Such information, which may include data or instructions to be executed using processor 382 for example, may be received from and outputted to the network, for example, in the form of a computer data baseband signal or signal embodied in a carrier wave. The baseband signal or signal embedded in the carrier wave, or other types of signals currently used or hereafter developed, may be generated according to several methods well-known to one skilled in the art. The baseband signal and/or signal embedded in the carrier wave may be referred to in some contexts as a transitory signal.

The processor 382 executes instructions, codes, computer programs, scripts which it accesses from hard disk, floppy disk, optical disk (these various disk-based systems may all be considered secondary storage 384), flash drive, ROM 386, RAM 388, or the network connectivity devices 392. While only one processor 382 is shown, multiple processors may be present. Thus, while instructions may be discussed as executed by a processor, the instructions may be executed simultaneously, serially, or otherwise executed by one or multiple processors. Instructions, codes, computer programs, scripts, and/or data that may be accessed from the secondary storage 384, for example, hard drives, floppy disks, optical disks, and/or other device, the ROM 386, and/or the RAM 388 may be referred to in some contexts as non-transitory instructions and/or non-transitory information.

In an embodiment, the computer system 380 may comprise two or more computers in communication with each other that collaborate to perform a task. For example, but not by way of limitation, an application may be partitioned in such a way as to permit concurrent and/or parallel processing of the instructions of the application. Alternatively, the data processed by the application may be partitioned in such a way as to permit concurrent and/or parallel processing of different portions of a data set by the two or more computers. In an embodiment, virtualization software may be employed by the computer system 380 to provide the functionality of a number of servers that is not directly bound to the number of computers in the computer system 380. For example, virtualization software may provide twenty virtual servers on four physical computers. In an embodiment, the functionality disclosed above may be provided by executing the application and/or applications in a cloud computing environment. Cloud computing may comprise providing computing services via a network connection using dynamically scalable computing resources. Cloud computing may be supported, at least in part, by virtualization software. A cloud computing environment may be established by an enterprise and/or may be hired on an as-needed basis from a third party provider. Some cloud computing environments may comprise cloud computing resources owned and operated by the enterprise as well as cloud computing resources hired and/or leased from a third party provider.

In an embodiment, some or all of the functionality disclosed above may be provided as a computer program product. The computer program product may comprise one or more computer readable storage medium having computer usable program code embodied therein to implement the functionality disclosed above. The computer program product may comprise data structures, executable instructions, and other computer usable program code. The computer program product may be embodied in removable computer storage media and/or non-removable computer storage media. The removable computer readable storage medium may comprise, without limitation, a paper tape, a magnetic tape, magnetic disk, an optical disk, a solid state memory chip, for example analog magnetic tape, compact disk read only memory (CD-ROM) disks, floppy disks, jump drives, digital cards, multimedia cards, and others. The computer program product may be suitable for loading, by the computer system 380, at least portions of the contents of the computer program product to the secondary storage 384, to the ROM 386, to the RAM 388, and/or to other non-volatile memory and volatile memory of the computer system 380. The processor 382 may process the executable instructions and/or data structures in part by directly accessing the computer program product, for example by reading from a CD-ROM disk inserted into a disk drive peripheral of the computer system 380. Alternatively, the processor 382 may process the executable instructions and/or data structures by remotely accessing the computer program product, for example by downloading the executable instructions and/or data structures from a remote server through the network connectivity devices 392. The computer program product may comprise instructions that promote the loading and/or copying of data, data structures, files, and/or executable instructions to the secondary storage 384, to the ROM 386, to the RAM 388, and/or to other non-volatile memory and volatile memory of the computer system 380.

In some contexts, the secondary storage 384, the ROM 386, and the RAM 388 may be referred to as a non-transitory computer readable medium or a computer readable storage media. A dynamic RAM embodiment of the RAM 388, likewise, may be referred to as a non-transitory computer readable medium in that while the dynamic RAM receives electrical power and is operated in accordance with its design, for example during a period of time during which the computer system 380 is turned on and operational, the dynamic RAM stores information that is written to it. Similarly, the processor 382 may comprise an internal RAM, an internal ROM, a cache memory, and/or other internal non-transitory storage blocks, sections, or components that may be referred to in some contexts as non-transitory computer readable media or computer readable storage media.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A method implemented in a communication system to update an application software providing real-time remote computation for a user equipment (UE), wherein the method comprises:
executing, by an application of a mobile edge computing system comprising one or more servers at a serving cell site of the UE, an instance of a first virtual machine hosting at least one user application for the UE, wherein the executing the instance of the first virtual machine comprises communicating, by the instance of the first virtual machine with the UE, first user interface traffic associated with execution of the at least one user application on the instance of the first virtual machine;
receiving, by the application of the mobile edge computing system, an application patch for updating the at least one user application;
launching, by the application of the mobile edge computing system in response to receiving the application patch, an instance of a second virtual machine to host at least an updated version of the at least one user application for the UE, wherein the updated version of the at least one user application comprises the application patch;
transferring, by the application of the mobile edge computing system, user data of the UE from the instance of the first virtual machine to the instance of the second virtual machine; and
executing, by the application of the mobile edge computing system, the instance of the second virtual machine hosting at least the updated version of the at least one user application for the UE, wherein the executing the instance of the second virtual machine comprises communicating, by the instance of the second virtual machine with the UE, second user interface traffic for execution of the updated version of the at least one user application on the instance of the second virtual machine.

2. The method of claim 1, wherein the launching the instance of the second virtual machine is further based on a base virtual machine image comprising the updated version of the at least one user application.

3. The method of claim 2, further comprising:
building the base virtual machine image based on a virtual machine image of the first virtual machine and the application patch.

4. The method of claim 2, wherein the application patch is a common application patch for a plurality of UEs located in a specific geographical region or associated with a specific cell site.

5. The method of claim 2, further comprising:
launching, by the application of the mobile edge computing system, based on the base virtual machine image, an instance of a third virtual machine to host at least the updated version of the at least one user application for another UE served by the serving cell site of the UE.

6. The method of claim 1, wherein the receiving the application patch comprises:
receiving, by the application of the mobile edge computing system via a backhaul link, the application patch.

7. The method of claim 1, wherein the receiving the application patch comprises:
receiving, by the application of the mobile edge computing system from another cell site via a line-of-sight (LOS) link, at least a portion of the application patch.

8. The method of claim 7, wherein the receiving the application patch from the other cell site via the LOS link is further in response to a fault at a backhaul link coupled to the mobile edge computing system.

9. The method of claim 1, further comprising:
deleting, by the application of the mobile edge computing system, the instance of the first virtual machine hosting the at least one user application for the UE; and
routing, by the application of the mobile edge computing system in response to deleting the instance of the first virtual machine, the second user interface traffic of the UE to the instance of the second virtual machine.

10. The method of claim 1, further comprising:
launching, by the application of the mobile edge computing system, based on a user configuration of the UE, the instance of the first virtual machine to host the at least one user application for the UE,
wherein the launching the instance of the second virtual machine to host the updated version of the at least one user application for the UE is further based on the user configuration of the UE.

11. The method of claim 1, wherein the UE comprises a wearable compute device.

12. A method implemented in a communication system to provide hand off of real-time remote computations for a user equipment (UE) transitioning between cell sites, wherein the method comprises:
executing, by an application of a first mobile edge computing system comprising one or more first servers at a first cell site serving the UE, an instance of a first virtual machine hosting at least one user application for the UE based on at least one of a user configuration or user data of the UE, wherein the executing the instance of the first virtual machine comprises:
executing, by the instance of the first virtual machine, the at least one user application; and
communicating, by the instance of the first virtual machine with the UE, first user interface traffic associated with the execution of the at least one user application on the instance of the first virtual machine;
launching, by an application of a second mobile edge computing system comprising one or more second servers at a second cell site, based on an indication of a handover of the UE to the second cell site, an instance of a second virtual machine to host the at least one user application for the UE; and
executing, by the application of the second mobile edge computing system, the instance of the second virtual machine hosting the at least one user application for the UE based on the at least one of the user configuration or the user data of the UE, wherein the executing the instance of the second virtual machine comprises:
executing, by the instance of the second virtual machine, the at least one user application; and
communicating, by the instance of the second virtual machine with the UE, second user interface traffic associated with execution of the at least one user application on the instance of the second virtual machine.

13. The method of claim 12, wherein the launching the instance of the second virtual machine is further based on location information of the UE.

14. The method of claim 12, further comprising:
transferring, by the application of the first mobile edge computing system, based on the indication of the handover of the UE to the second mobile edge computing system, the at least one of the user configuration or the user data of the UE to the second mobile edge computing system.

15. The method of claim 12, wherein the executing the instance of the first virtual machine hosting the at least one user application of the UE and the executing the instance of the second virtual machine hosting the at least one user application of the UE are associated with the same terminal session of the UE.

16. A system comprising:
a mobile edge computing system communicatively coupled to at least one of a radio access node or an access point, wherein the mobile edge computing system comprises:
at least one processor;
at least one non-transitory memory; and
an application comprising instructions stored at the at least one non-transitory memory, which when executed by the at least one processor, causes the application to:
launch an instance of a virtual machine to host at least one user application for a user equipment (UE), wherein the launching is based on the UE being within a range of the access node or the access point that is in communication with the mobile edge computing system and a subscription of the UE; and
execute an instance of a virtual machine hosting the at least one user application for the UE, wherein the executing the instance of the virtual machine comprises:
receiving, from the UE, a user interface input;
executing the at least one user application based on the user interface input; and
transmitting, to the UE, based on the executing the at least one user application, a user interface output for display at the UE.

17. The system of claim 16, wherein the launching the instance of the virtual machine to host the at least one user application for the UE is further based on a resource availability of the virtual machine satisfying a resource requirement associated with a subscription level of the UE.

18. The system of claim 16, wherein:
the instructions, when executed by the at least one processor, further causes the application to:
determine, based on a characteristic of the at least one user application for the UE, at least one of a computing resource requirement or a memory resource requirement for hosting the at least one user application for the UE, and
the launching the instance of the virtual machine to host the at least one user application for the UE is further based on a resource availability of the virtual machine satisfying the at least one of the determined computing resource requirement or the memory resource requirement.

19. The system of claim 16, wherein the launching the instance of the virtual machine to host the at least one user application for the UE is further based on a timer period specified by the subscription of the UE.

20. The system of claim 16, further comprising:
the access node configured to provide radio frequency (RF) energy for powering the UE and connectivity between the mobile edge computing system and the UE.
